(19) United States
(12) Patent Application Publication
(10) Pub. No.: US 2007/0186094 A1
(43) Pub. Date: Aug. 9, 2007

(54) Specification based routing of utility network systems

(75) Inventors: Sami Ghantous, Manchester, NH (US); Bo Noren, Boras (SE)

Correspondence Address: PATTERSON & SHERIDAN, L.L.P., 3040 POST OAK BOULEVARD, SUITE 1500, HOUSTON, TX, 77056, US

(73) Assignee: Autodesk, Inc.

(21) Appl. No.: 11/339,423

(22) Filed: Jan. 25, 2006

(51) Int. Cl. H04L 9/00

(52) U.S. Cl. 713/153

(57) ABSTRACT

Embodiments of the invention allow users to compose a computer-aided design (CAD) model of a utility network. As a user specifies the routing characteristics of the utility the network (i.e., the position, length, and direction of segments of the network), a CAD application automatically selects the network parts to include in the CAD model based on a routing specification. Thus, the process of composing CAD model of a network of a utility network is greatly simplified.

### BACKGROUND OF THE INVENTION

1. Field of the Invention

The present invention generally relates to computer software. More specifically, the present invention relates to software used to create a computer model of a utility network system.

2. Description of the Related Art

The term computer-aided design (CAD) generally refers to a broad variety of computer-based tools used by architects, engineers, and other construction and design professionals. CAD applications may be used to construct computer models representing virtually any real-world construct. Commonly, CAD applications are used to generate computer models and drawings related to utility networks. For example, a CAD application may be used to compose a model of a connected system of pipes, electrical, or HVAC ductwork components. The models may be used to create a variety of two-dimensional (2D) and three-dimensional (3D) views of the utility network. Additionally, such models may be used to generate construction, engineering, and other documentation related to the utility network such as bills of materials, requirements, etc.

Some CAD applications allow users to compose a computer model in much the same way paper drawings are composed—by drawing a set of lines, arcs, circles, etc. to create a representation of the object being modeled. More sophisticated CAD applications allow users to compose a model using architecture, engineering, and construction elements that correspond to physical elements of the system being modeled. For example, a CAD application may provide a catalog of elements found in a real-world pipe system. Thus, to compose a model of the pipe system, a designer or engineer selects pipe elements with various dimensions, joints, elbows, transitions. The model includes the selected pipe segments, connections between segments, and the “routing” or geometry of the system.

Generally, “routing” refers to the process of a designer specifying the topology of a utility network by selecting parts from the catalog of elements and laying them out, piece-by-piece until the CAD model is completed. Thus, routing may involve both the selection and arrangement of elements in the CAD model. Typically, a designer selects parts according to a specification created for a particular enterprise or for a particular project. The routing specification identifies which network elements should be used in a given utility network, such as the pipes and pipe connections to be used in the network, Often the routing specification for a network of pipes specifies which elements to use in the CAD model based on the diameter of the pipe. For example, a routing specification may specify that pipes above a certain diameter should be connected using a butt-welded joint, while smaller pipes should be connected using a flange connector.

Thus, while routing a pipe system (or other utility network) the designer must continually refer to the appropriate specification. While this approach works as intended, it requires a designer to continually reference the routing specification while composing a CAD model, which may lead to errors in the designer accurately selecting the correct part.

Moreover, this approach relies on the routing specification remaining static over the course of a design-build cycle. In reality, however, project requirements are often subject to change. Using the approach of composing a utility system set forth above requires a user to manually review and change any affected elements each time the routing specification changes. Similarly, if an engineer desires to evaluate changes to the routing specification used to create an exiting a CAD model, then the engineer must manually create a new CAD model, or make dramatic changes to the existing one.

Accordingly, there is a need for a CAD application that allows users to compose a CAD model of a utility network without requiring the user to continually reference the routing specification while composing the CAD model.

### SUMMARY OF THE INVENTION

One embodiment of the invention includes a method of constructing a CAD model of a utility network. The method includes providing a catalog of network elements, wherein each network element specifies a geometry of a component that may be included in the CAD model and providing an interface for specifying the routing characteristics of the utility network. The method also includes receiving a routing specification that defines which network elements should be used in the CAD model, based on a selectable attribute of the utility network elements. For example, the selectable attribute may be based on the diameter of pipes represented by network elements that may be included in the CAD model. The user composes the CAD model by specifying the desired routing characteristics of the utility network. In response, the method includes inserting network elements from the catalog of network elements into the CAD model based on to the routing specification and the selectable attribute. Generally, the routing characteristics define the topology of the utility network, including the position, direction, and length of segments of the utility network within the CAD model.

One advantage of the disclosed method is that the user specifying the routing characteristics of the utility network is not required to individually select which network elements are inserted into the CAD model. Instead, as the user specifies the routing characteristics of the utility network, a CAD application selects which network parts to insert into the CAD model, based on the routing specification. Thus, the process of composing a CAD model of a network of a utility network is greatly simplified.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer-aided design application environment, according to one embodiment of the invention.

FIG. 2 is an exemplary screen shot illustrating a view of a pipe network, according to one embodiment of the invention.

FIG. 3 is an exemplary screen shot illustrating a view of a pipe network, according to one embodiment of the invention.

FIGS. 4A-4D are exemplary screen shots illustrating the process of composing a model of a pipe network based on defined routing specifications, according to one embodiment of the invention.

FIG. 5 is a flow diagram illustrating a method for routing a utility network using a CAD application and routing specification, according to one embodiment of the invention.

FIG. 6 is a flow diagram illustrating a method for applying a routing specification to a CAD model of a utility network, according to one embodiment of the invention.

### DETAILED DESCRIPTION OF THE PREFERRED EMBODIMENTS

Embodiments of the invention provide a computer-aided design (CAD) environment that allows an engineer to compose a model of a utility network according to a routing specification specified for that network or design project. The routing specification allows the engineer to specify the topology of the network and the CAD application automatically places the proper utility components (e.g. pipe segments, elbows, joints, transitions, tees, etc.) in the network according to the routing specification. Typically, the routing specification identifies the proper utility components based on some aspect of the network being modeled, such as the size or diameter of pipes being routed by the designer. Alternatively, the proper utility components may depend on the material being routed, the location of the network (e.g., indoor/outdoor, above/below ground, etc), or any other criteria specified by the routing specification.

To facilitate a description of the invention, the following discussion describes an embodiment of a CAD application used to compose a CAD model of a pipe network. Accordingly, aspects of the invention are described in reference to elements one would expect to be present in such a utility network such as pipe segments and connection types. However, the invention is not limited to routing specifications for a pipe network and may readily be adapted to model other utility networks such as electrical, communications or HVAC networks.

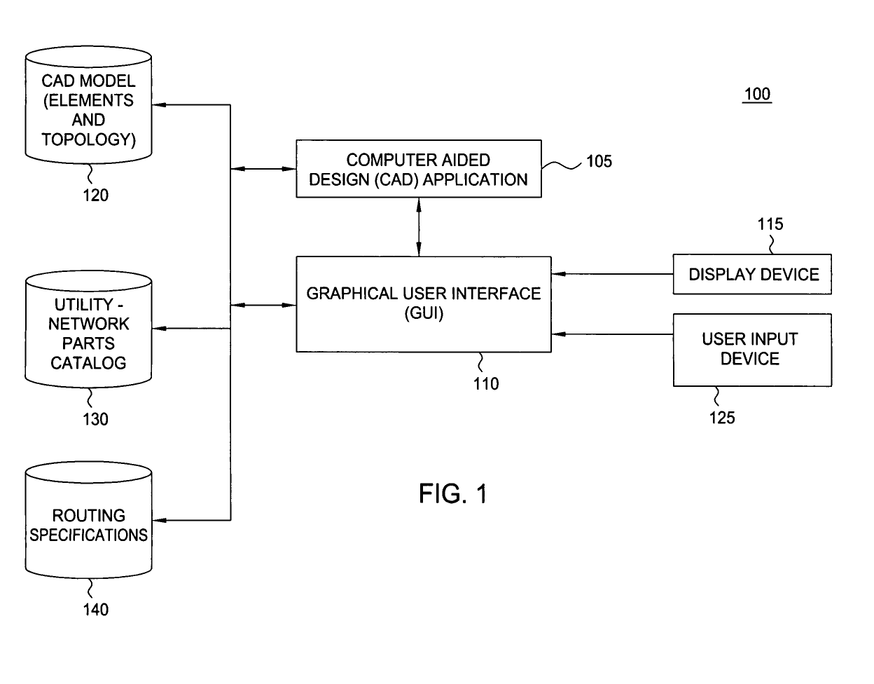

FIG. 1 is a block diagram illustrating a computer-aided design application environment 100, according to one embodiment of the invention. As shown, the CAD environment 100 includes, without limitation, a CAD application program 105, a graphical user interface (GUI Interface) 110, CAD model 120, user input devices 125, a display device 115, a drawing elements catalog 130 and routing specification 140.

In one embodiment, the CAD application 105 provides a computer program that allows users to create, edit, and view any of the files associated with a CAD model 120. For a project related to the architecture, engineering, or design of a pipe network, the Autodesk Building System program suite available from Autodesk®, Inc. may be used. The CAD application 105 and graphical user interface 110 are configured to access data related to the CAD model 120, the utility network parts catalog 130 and the routing specification 140.

The CAD model 120 includes the collection of drawings, drawing templates, models, images, etc., associated with a model of a particular pipe network. The CAD model 120 includes both the topology (i.e., the spatial location and orientation of pipe network elements) as well as parts included in a given pipe network (i.e., the pipe segments, materials, and connection types between segments). In addition, the CAD model 120 may include additional information about the pipe network, such as the routing specification 140 used to create the network, part suppliers, model authors, revisions, etc. In one embodiment, the CAD model 120 may be composed from architecture, engineering and construction elements included in the parts catalog 130. Thus, in this example, presented herein, the parts catalog 130 provides a set of drawing elements or objects available for composing a pipe network. Accordingly, the parts catalog 130 would include elements representing pipes of various sizes, materials, and properties and elements representing connectors such as flanges, threaded joints, bends, butt or socket welded connections, threaded connections, etc.

The routing specification 140 defines which network elements from the parts catalog 130 should be used when a designer composes the CAD model 120. As the user specifies the desired routing of the utility network, the CAD application 105 automatically adds elements to the CAD model 120, based on the routing specification 140. For example, the routing specification 140 may specify which elements to use in the CAD model 120, based on the size of pipe being routed. In such a case, the designer selects a pipe size and creates the desired routing (i.e., the position, direction and length of networks segments) of the pipe network. The CAD application 105 adds network elements to the CAD model 120, based on the parts specified by the routing specification 140 for the size of pipe being routed.

The GUI interface 110 may provide elements (e.g. menus, buttons, drop-down lists, check-boxes, etc.) that allow a user to compose the CAD model 120. Display device 115 provides users with a visual representation the CAD model 120. Input devices 125 allow a user to interact with the CAD model 120 and GUI interface 110. Display device 115 may include a CRT monitor or LCD display. Typically, user input devices 125 include a mouse pointing device and a keyboard but are not so limited and other input devices 125 that may be provided include tablets, touch screens, etc.

The CAD environment 100 illustrated in FIG. 1 may include software applications and associated data files configured for existing computer systems, e.g., desktop computers, server computers, laptop computers, tablet computers, and the like. The components illustrated in CAD environment 100, however, are not limited to any particular computing environment, programming language, or computer hardware and/or software combination, and embodiments of the invention may be adapted to take advantage of new computing systems as they become available. Additionally, the components illustrated in FIG. 1 may be deployed on individual computer systems or on distributed systems configured to communicate over computer networks ranging from small local area networks to large wide area networks such as the Internet. For example, the CAD application 105 may be a server component executing on one computer system in communication with a graphical user interface 110 executing on another computer system.

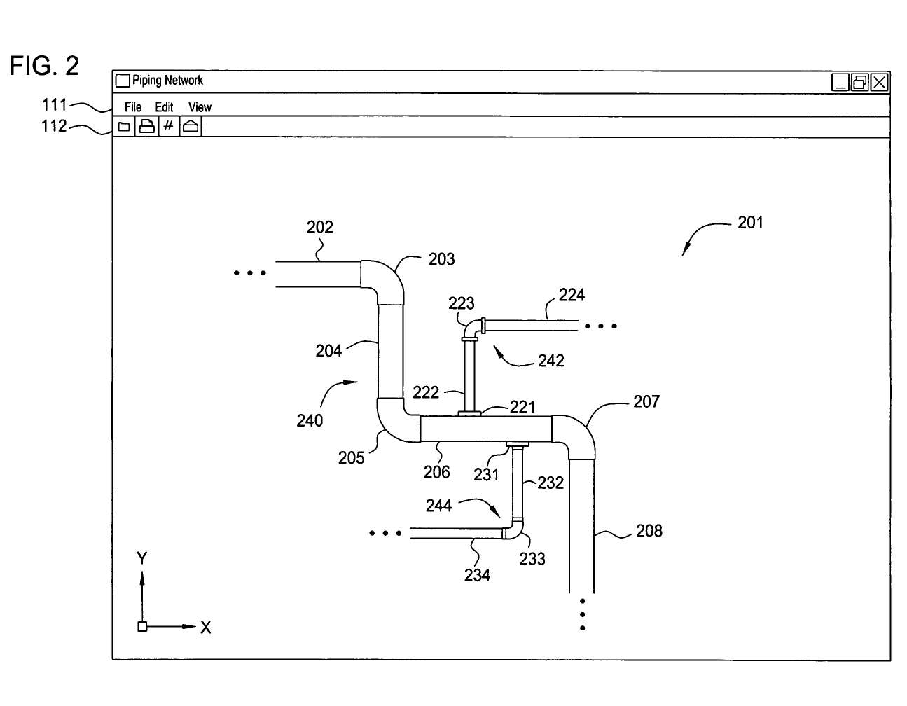

FIG. 2 is an exemplary screenshot illustrating a view of a pipe network 201, according to one embodiment of the invention. Illustratively, the screen shot includes elements of the GUI interface 110 including a menu bar 111 and button bar 112. As shown, the topology of pipe network 201 includes three general pipe runs; a primary pipe run 240, and two tied-in pipe runs 242 and 244. The pipe network 201 may represent, for example, a cooling water system that includes multiple tie-ins to a main feed.

As shown, the primary pipe run 240 represents a large diameter pipe that includes four pipe segments 202, 204, 206 and 208, and joining elements 203, 205, and 207. In this example, the primary pipe run 240 represents a 4″ pipe, and the joining elements 203, 205, and 207 represent butt welded connections. Connected to the primary pipe run 204 is the secondary pipe run 242. The secondary pipe run 242 includes a tie-in element 221, pipe segments 222 and 224, and a joining element 223. In this example, the secondary pipe run 242 is included to represent a 2″ pipe and the joining element 223 represents a flange connection between the pipe segments 222 and 224. Also connected to the primary pipe run 240 is the secondary pipe run 242 that includes a tie-in element 231, pipe segments 232 and 234, and a joining element 233. In this example, this secondary pipe run 242 represents a 1″ pipe and the joining element 233 represents a threaded connection between the pipe segments 232 and 234. Each of the pipe segment properties, tie-ins and connection types may be specified by routing specification 140.

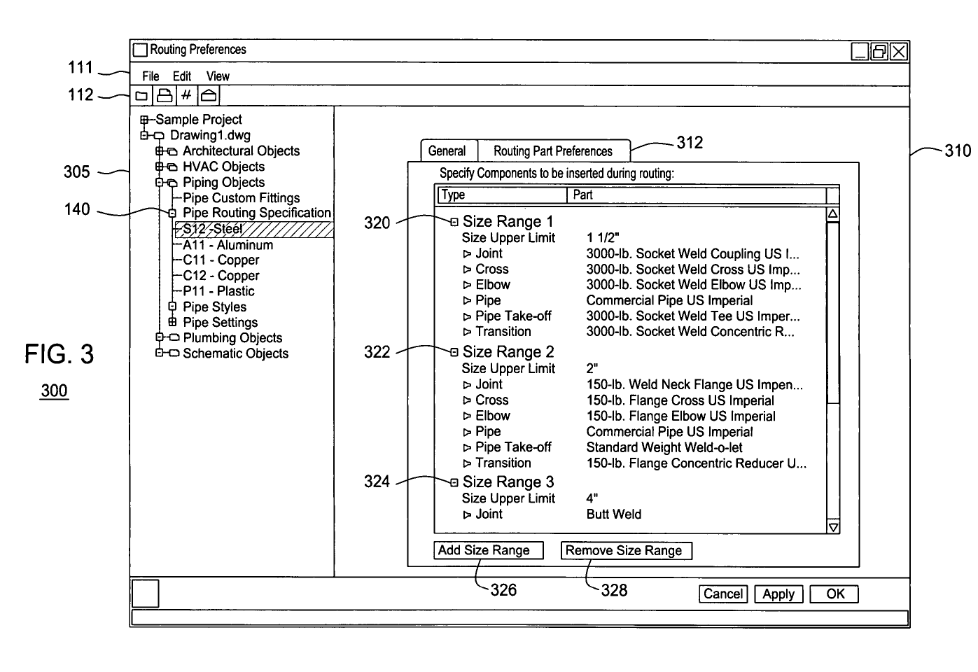

FIG. 3 is an exemplary screenshot illustrating an interface 300 used to define routing specifications for a pipe network, according to one embodiment of the invention. More specifically, FIG. 3 illustrates an example of the routing specification used to select network elements for pipe network 201. The interface 300 includes elements of the GUI interface 110 including a menu bar 111 and button bar 112. Additionally, the interface 300 includes panels 305 and 310.

Panel 305 allows users to navigate different aspects of CAD modeling project. Illustratively, the panel 305 displays a variety of configurable options for a modeling project arranged in hierarchy that allows a user to expand or collapse different elements of the hierarchy. As shown, the panel 305 includes a list of three routing specifications 140. Specifically, an “S12,” an “A11,” and a “P11” routing specification 140. Each of these may a different collection of network elements from parts catalog 130 to use when a designer composes a CAD model 120 of a pipe network. A model 120 may include pipe runs based multiple routing specifications. The “S12,” “A11,” and “P11” labels may correspond to routing specifications 140 created for a particular project or by a particular enterprise.

Illustratively, the routing specification 140 labeled “S12” is selected and panel 310 displays the network part preferences that correspond with the “S12” routing specification 140. Panel 310 of interface 300 also shows a tabbed interface that includes a routing preferences tab 312 showing the details of the “S12” routing specification 140. More specifically, the “S12” routing specification 140 includes three different size ranges 320, 322, and 324. Each size range includes a set of network part elements to use in a CAD model 120 when a user creates a pipe network within one of these three size ranges. Additionally, panel 310 includes button 326 that allows a user to create a size range for a routing specification 140 and a button 328 that allows a user to remove a size ranges from a routing specification 140.

The routing preferences for the size ranges 320, 322, and 324 correspond to the pipe runs 240, 242, and 244 shown in FIG. 2, respectively. Size range 320 specifies drawing elements that should be used when routing pipe with a size diameter of less 1½″. Accordingly, pipe run 244 shown in FIG. 2 (a 1″ diameter pipe-run) is composed from the network elements specified by size range 320. As shown, size range 320 specifies the specific joint, cross, elbow, pipe, and transition elements to use when a designer composes a pipe run up to 1½″ in diameter. Tie-in element 231, pipe segments 232 and 234, and joining element 234 shown in FIG. 2 reflect parts selected according to size range 320.

Similarly, size range 322 specifies drawing elements that should be used when routing pipe when routing pipe between 1½″ and 2″ in diameter. Pipe network 201 includes the pipe run 242 (a 1″ diameter pipe-run) with elements selected from size range 322. Specifically, tie-in element 221, joining element 223, and pipe segments 222 and 224 reflect parts according to size range 322. Finally, size range 324 specifies drawing elements that should be used when a designer creates a pipe run representing pipe between 2″ and 4″ in diameter. Pipe run 240 (a 4″ diameter pipe-run) is routed using elements specified by size range 324.

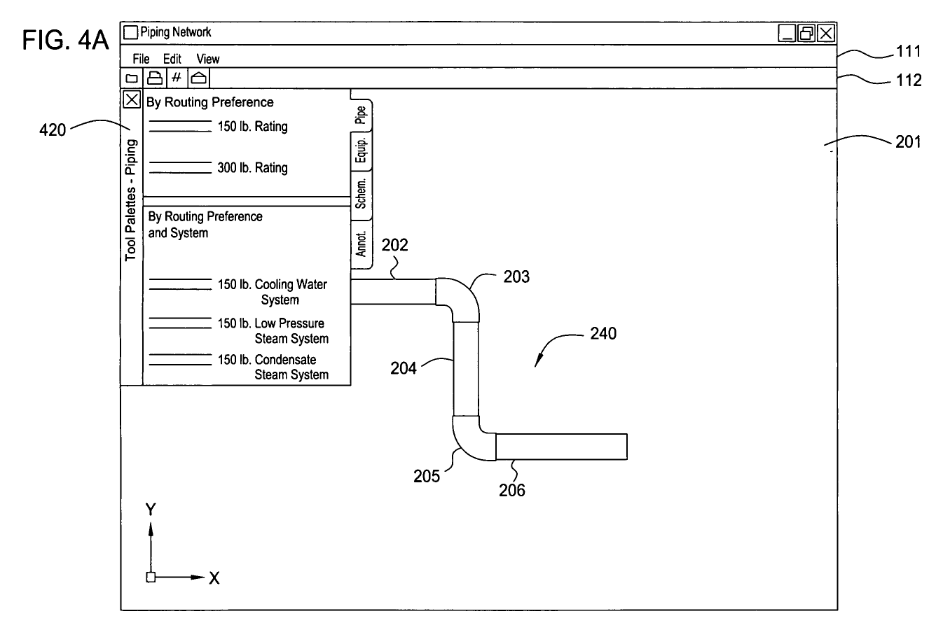

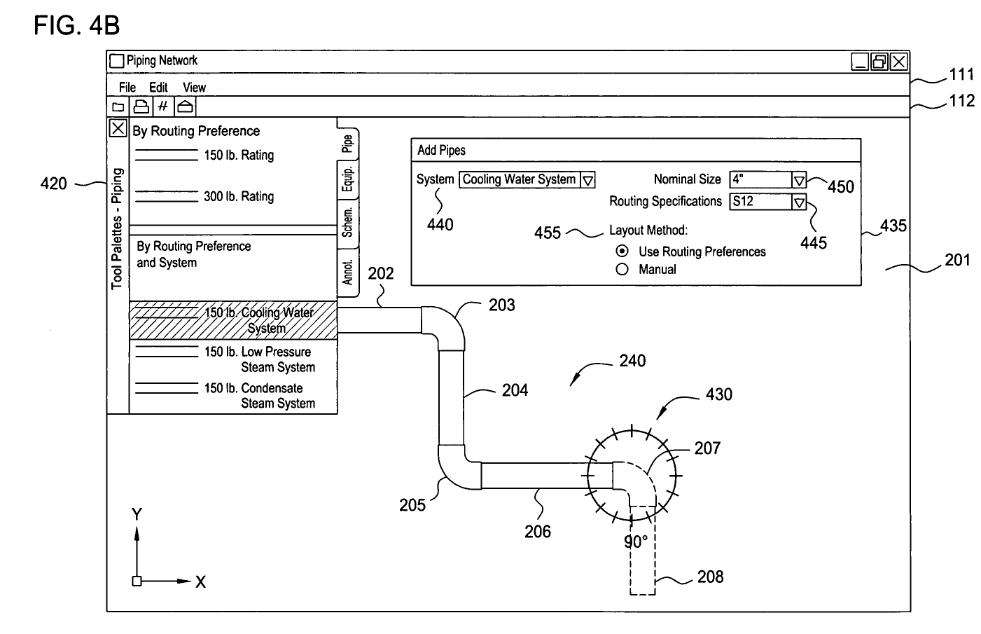

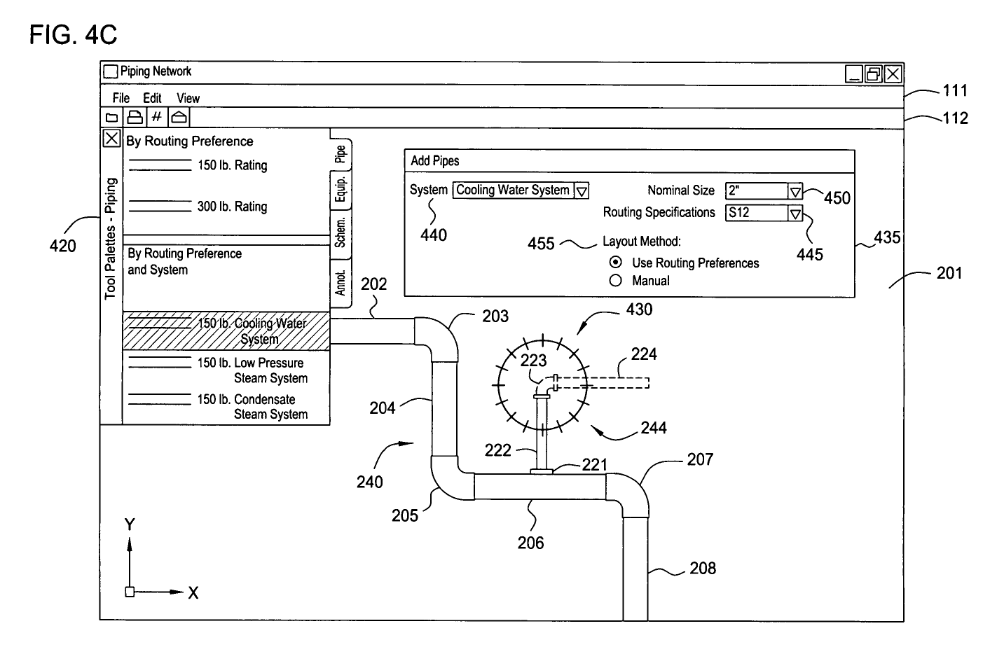

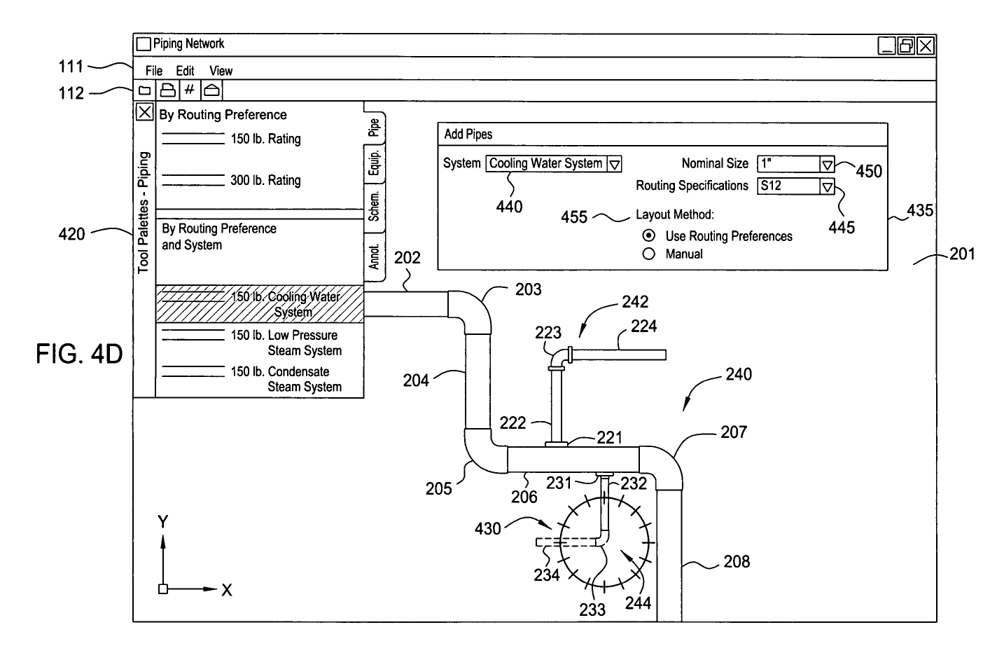

FIGS. 4A-4D are exemplary screen shots illustrating the process of constructing a CAD model 120, according to one embodiment of the invention. More specifically FIGS. 4A-4D illustrate the creation of pipe network 201, according to the example “S12” routing specification 140 shown in FIG. 3. As the user specifies the topology of pipe network 201, the network elements included in the pipe network 201 are automatically determined based on the routing specification 140 and the size of pipe selected by the user. Thus, the user specifies the desired routing and topology for a utility network, and the CAD application 105 adds the appropriate parts to the CAD model 120, based on routing specification 140.

FIG. 4A is a screenshot that displays a portion of pipe network 201 after the user has routed a portion of pipe run 240. As shown, pipe segments 202, 204, and 206 and joining elements 203 and 205 have been added to the pipe network 201. Tool palette 420 allows the user to route additional pipe runs. In this example, a user may select to create pipe run by “routing preference” or by both “routing preference” and by “pipe system.” In one embodiment, a CAD model 120 may include multiple pipe networks systems (e.g., a hot and cold water pipe network each connected to a waste water return pipe network). Accordingly, the tool palette 420 may allow the user to specify which pipe system to add new pipe segments.

FIG. 4B is a screenshot that displays a portion of pipe network 201. Specifically, FIG. 4B shows the user adding pipe segment 208 to pipe run 240. As shown, the user has selected to route “150 lb” pipe for the “cooling water” system from the tool palette 420. In response, the GUI interface 110 may be configured to display an “add-pipes” dialog box 435. Dialog box 435 includes drop down boxes 450 and 455 which allow the user to specify the pipe size and routing specification 140 to use for in modeling a pipe run. In this example, the user has selected to route 4″ diameter pipe using the “S12” routing specification 140. Accordingly, size range 324 from the “S12” routing specification 140 is used to select pipe segments, connections and fitting to add to the pipe network 201. Dialog box 435 may include other user preferences to use in routing additional pipe segments. For example, as shown in FIG. 4B, dialog box 435 includes a drop-down box 440 allowing the user change the selected pipe network being routed. Also, radio buttons 455 allow the user to select the layout method to use the routing specifications. As shown, the user has selected to route pipe network 201 using the size and routing preferences selected in drop down boxes 445 and 450.

A compass 430 provides an element of GUI interface 110 that allows the user to specify the desired routing (i.e., the position, direction, and length) of additional pipe segments as they are added to pipe network 201. As shown, the user has placed the compass 430 at the desired location to begin a new pipe segment. The dashed lines shown for pipe segment 208 and connection 207 provide the user with a preview of the network elements that will be added to the pipe network 201 if the user confirms the current selection. Additionally, to join pipe segments 208 and 206, the CAD apparition 105 automatically selects to add joining element 207 (a butt welded joint) to join pipe segments 206 and 208, as specified by size range 324. Thus, the network elements used to create the additional pipe segment of pipe network 201 are determined by routing specification based on the routing specified by the user.

FIG. 4C is a screenshot that displays a portion of pipe network 201. Specifically, FIG. 4C shows the user adding pipe segment 224 to pipe run 242. In this example, the user has completed routing pipe run 240 and began routing the pipe run 242 that includes tie-in element 221, pipe segments 222 and 224, and joining element 223. To route the pipe run 242, the user changes the size of pipe being routed in the drop-down box 450 to reflect a 2″ pipe diameter and uses the compass 430 to route new segments. Specifically, the user specifies the location of the tie-in 221 and specifies the length and direction of the pipe segment 222. In response, the CAD application 105 inserts elements from the parts catalog 130, including the tie-in 221 and the pipe segment 222, based on size range 322 specified by the routing specification 140. Next, the user specifies the length and direction for pipe segment 224, and the CAD application 105 inserts the appropriate network elements for joining element 223 and pipe segment 224 based on the routing specification 140.

Finally, FIG. 4D is a screenshot that displays a portion of pipe network 201. Specifically, FIG. 4D shows the user adding pipe segment 234 to pipe run 244. In this example, the user has completed routing pipe runs 240 and 242 and began routing the pipe run 244 that includes tie-in element 231, pipe segments 232 and 234, and joining element 233. To route pipe run 244, the user changes the size of pipe being routed in drop-down box 450 to reflect a 1″ pipe diameter and uses the compass 430 to route new segments. Using the compass 430, the user specifies the location for tie-in 231. The user then specifies the length and direction for pipe segment 232 and 234. In response, the CAD application 105 adds the appropriate parts from network elements catalog for tie-in element 231 and pipe segments 232 and 234, and also adds the joining element 233 to connect pipe segments 232 and 234. The CAD application 105 determines which network elements to the pipe network 201 according to size range 320 specified for pipe runs up to 1½″ in diameter.

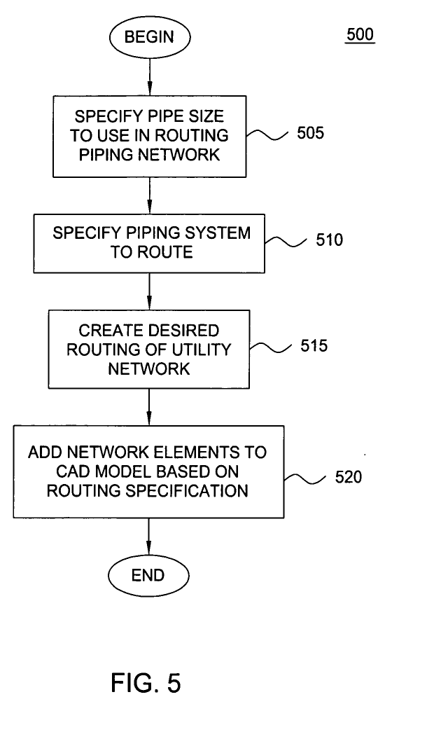

FIG. 5 is a flow diagram illustrating a method 500 for routing a utility network using the CAD application 105 and the routing specification 140, according to one embodiment of the invention. Although the method 500 is described in conjunction with the CAD environment 100 of FIG. 1, Persons skilled in the art will understand that any system configured to perform the method steps illustrated in FIG. 5, in any order, is within the scope of the present invention.

The method 500 begins at step 505 where the user specifies the pipe size to use in routing a pipe network. For example, as shown in FIGS. 4B-4D, the GUI 110 presents the user with drop down box 450 for specifying the diameter of pipe segments to route in pipe network 201. At step 510, the user may specify a particular pipe network to use for routing additional pipe segments. As stated, the CAD model 120 may include multiple utility networks in the same model. In such a case, the user selects which pipe network to use in creating new routing topology (i.e., the location, length and direction of segments in the pipe network).

At step 515, the user creates the desired routing for the utility network being modeled. Thus, the user may compose the CAD model 120 of the pipe network by specifying a beginning location for a pipe segment along with the length and direction of the segment. For example, the compass 430 illustrated in FIGS. 4C-4D shows the user in the process of adding pipe runs 242 and 244 to the existing pipe run 240 by specifying the routing for segments 224 and 234, respectively.

At step 520, the CAD application 105 adds network elements from the parts catalog 130 to the CAD model 120 according to the routing specification 140. The CAD application 105 adds network elements at locations that correspond with the routing specified by the user. In addition, the CAD application may add elements such as joints and fittings between different segments automatically, also based on the routing specification 140. Thus, once the size of pipe has been selected, the user may compose the pipe network 201 by simply specifying the desired routing. In response the CAD application adds the correct network elements from the drawing catalog 130, as specified in the routing specification 140. Therefore, the process of composing a CAD model 120 of a utility network is greatly simplified, as network elements for the utility network are added automatically as the user creates the desired routing.

Additionally, embodiments of the invention allow the user to change the routing specification 140 used for a pipe network or for a selected group network elements. For example, the user may change the definition of size range 324 of routing specification 140 and apply these changes to the pipe network 201. In such a case, the elements of pipe run 240 may be updated based on changes to size range 324. This relieves the user from having to manually replace network elements whenever a change occurs to the underlying routing specifications 140. The user may also create entirely different routing specifications 140 and apply them, to a single element or the portions of a pipe run or an entire pipe run.

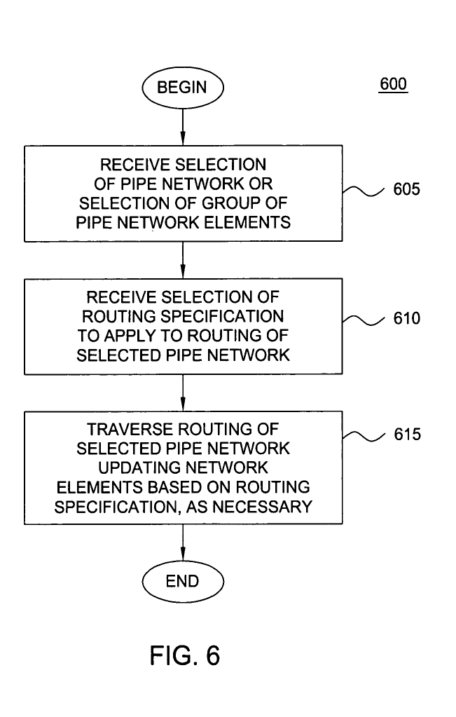

FIG. 6 is a flow diagram illustrating a method 600 for applying a routing specification 140 to a CAD model of a utility network, according to one embodiment of the invention. Although the method 600 is described in conjunction with the CAD environment 100 of FIG. 1, persons skilled in the art will understand that any system configured to perform the method steps illustrated in FIG. 6, in any order, is within the scope of the present invention.

The method 600 begins at step 605 where the CAD application 105 receives a selection of a pipe network or a group of network elements. For example, the pipe network 201 includes pipe runs 240, 242, and 244. In turn, pipe runs 240, 242, and 244 include network elements selected from the parts catalog 130, based on the “S12” routing specification 140 and a pipe size specified by the user during the routing process. At step 605, the user may select elements of pipe runs 240, 242 or 244, select elements from multiple pipe runs or select the entire pipe network 201.

At step 610, the CAD application 105 receives a selection of the routing specification 140 to apply to the topology of the pipe network specified at step 605. At step 615, the CAD application 105 traverses the routing of the pipe network specified at step 605 and determines whether any of the network elements need to be updated based on the routing specification 140 selected at step 610. If the CAD application 105 determines that a network element currently in the CAD model 120 is not the element specified by the selected routing specification 140, then the network element is replaced with the correct network element. Additionally, the CAD application 105 may be configured to evaluate whether a replacement to one network element may require changes to any connected elements. Once the CAD application 105 has traversed through the routing of the pipe network specified at step 605, and replaced any network elements based on the routing specification 140, the method terminates at step 630.

As described, embodiments of the invention allow users to compose a model of a utility network using a routing specification 140. Users may compose a model of a utility network by specifying the desired routing, without having to select each individual component of the utility network. Instead, as the user specifies the routing for a utility network, the CAD application 105 automatically adds the correct part to the CAD model 120, based on the routing specification 140. Thus, the time required to compose a CAD model 120 a utility network may be substantially reduced. Further, an existing CAD model 120 network may be updated to reflect changes to the routing specification 140 by applying the desired routing specification 140 to the topology an existing CAD model 120.

While the foregoing is directed to embodiments of the present invention, other and further embodiments of the invention may be devised without departing from the basic scope thereof, and the scope thereof is determined by the claims that follow.

What is claimed is:

1. A method for constructing a computer-aided design model (CAD) model of a utility network, comprising:
providing a catalog of network elements, wherein each network element specifies a geometry of a component that may be included in the CAD model of the utility network;
receiving a routing specification that defines which network elements should be used in the CAD model based on a selectable attribute of the network elements;
providing an interface for specifying the routing characteristics of the utility network; and
in response to a user specifying the routing characteristics of the utility network, inserting network elements from the catalog into the CAD model based on to the routing specification and the selectable attribute of the network elements.

2. The method of claim 1, wherein the utility network comprises a pipe network, and the catalog of network elements provides a plurality of pipe elements.

3. The method of claim 2, wherein the routing characteristics of the utility network include the location, direction, and length of a segment of a pipe run.

4. The method of claim 2, wherein the selectable attribute of the network elements comprises a diameter of the pipe elements.

5. The method of claim 2, wherein the selectable attribute of the network elements comprises the material composition of a pipe.

6. The method of claim 1, further comprising the steps of:
receiving a second routing specification;
receiving a set of network elements selected from the CAD model;
applying the second routing specification to the routing characteristics of the selected set of network elements.

7. The method of claim 6, wherein the step of applying the second routing specification to the routing characteristics of the selected set of network elements comprises:
comparing the network elements in the CAD model with elements specified by the second routing specification, and
replacing network elements in the CAD model that do not match the element specified by the routing specification with a network element specified by the second routing specification.

8. The method of claim 1, wherein the utility network comprises an electrical, communications, or HVAC network.

9. A computer-readable medium storing instructions for causing a computing device to construct a computer-aided design model (CAD) model of a utility network, including the steps of:
providing a catalog of network elements, wherein each network element specifies a geometry of a component that may be included in the CAD model of the utility network;
receiving a routing specification that defines which network elements should be used in the CAD model based on a selectable attribute of the network elements;
providing an interface for specifying the routing characteristics of the utility network; and
in response to a user specifying the routing characteristics of the utility network, inserting network elements from the catalog into the CAD model based on to the routing specification and the selectable attribute of the network elements.

10. The computer-readable medium of claim 9, wherein the utility network comprises a pipe network, and the catalog of network elements provides a plurality of pipe elements.

11. The computer-readable medium of claim 10, wherein the routing characteristics of the utility network include the location, direction, and length of a segment of a pipe run.

12. The computer-readable medium of claim 10, wherein the selectable attribute of the network elements comprises a diameter of the pipe elements.

13. The computer-readable medium of claim 10, wherein the selectable attribute of the network elements comprises the material composition of a pipe.

14. The computer-readable medium of claim 9, wherein the steps further include:
receiving a second routing specification;
receiving a set of network elements selected from the CAD model;
applying the second routing specification to the routing characteristics of the selected set of network elements.

15. The computer-readable medium of claim 14, wherein the step of applying the second routing specification to the routing characteristics of the selected set of network elements comprises:
comparing the network elements in the CAD model with elements specified by the second routing specification, and
replacing network elements in the CAD model that do not match the element specified by the routing specification with a network element specified by the second routing specification.

16. The computer-readable medium of claim 9, wherein the utility network comprises an electrical, communications, or HVAC network.

17. A computing device comprising:
a processor; and
a memory configured to store an application that includes instructions which, when executed by the processor, cause the processor to perform operations for constructing a computer-aided design model (CAD) model of a utility network, including the steps of:
providing a catalog of network elements, wherein each network element specifies a geometry of a component that may be included in the CAD model of the utility network;
receiving a routing specification that defines which network elements should be used in the CAD model based on a selectable attribute of the network elements;
providing an interface for specifying the routing characteristics of the utility network; and
in response to a user specifying the routing characteristics of the utility network, inserting network elements from the catalog into the CAD model based on to the routing specification and the selectable attribute of the network elements.

18. The system of claim 17, wherein the utility network comprises a pipe network, and the catalog of network elements provides a plurality of pipe elements.

19. The system of claim 18, wherein the routing characteristics of the utility network include the location, direction, and length of a segment of a pipe run.

20. The system of claim 18, wherein the selectable attribute of the network elements comprises a diameter of the pipe elements.

21. The system of claim 18, wherein the selectable attribute of the network elements comprises the material composition of a pipe.

22. The system of claim 17, wherein the steps further include:
receiving a second routing specification;
receiving a set of network elements selected from the CAD model;
applying the second routing specification to the routing characteristics of the selected set of network elements.

23. The system of claim 22, wherein the step of applying the second routing specification to the routing characteristics of the selected set of network elements comprises:
comparing the network elements in the CAD model with elements specified by the second routing specification, and
replacing network elements in the CAD model that do not match the element specified by the routing specification with a network element specified by the second routing specification.
